(19) United States
(12) Patent Application Publication
(10) Pub. No.: US 2017/0213223 A1
(43) Pub. Date: Jul. 27, 2017

(54) SYSTEM AND METHOD FOR VERIFIED MERCHANT INDUSTRY CODE ASSIGNMENT

(71) Applicant: AMERICAN EXPRESS TRAVEL RELATED SERVICES COMPANY, INC., New York, NY (US)

(72) Inventors: Ravi Batra, Jersey City, NJ (US); Dheeraj Chandrashekar, San Mateo, CA (US); Vic S. Chawla, Berkeley Heights, NJ (US); Ashish Dabas, New York, NY (US); Vernon Marshall, London (GB); Sangarsh Nigam, New York, NY (US); Ashish Kapatia Sharma, Jersey City, NJ (US)

(73) Assignee: AMERICAN EXPRESS TRAVEL RELATED SERVICES COMPANY, INC., New York, NY (US)

(21) Appl. No.: 15/003,487

(22) Filed: Jan. 21, 2016

(51) Int. Cl. G06Q 30/02; G06N 99/00; G06F 17/30

(52) U.S. Cl. CPC G06Q 30/0201; G06F 17/30572; G06N 99/005

(57) ABSTRACT

Systems and methods of improving the operation of a transaction network and transaction network devices is disclosed. A VIC assignment system may comprise various modules and engines as discussed herein wherein a VIC code may be determined and assigned to a merchant for establishing proper usage of differentiated transaction instruments according to their proper purposes, marketing and cross-marketing of differentiated transaction instruments, and provision of value-added services, such as credit risk evaluation, fraud detection, bonusing, and dispute arbitration. For instance, a VIC code may be identified, whereby the VIC assignment system may tailor the handling of the transactions, such as by denying them, whereby the transaction network may actively deter misuse of transaction products, or tailor the handling of electronically delivered advertisements, such as by targeting them, whereby the transaction network more properly functions according to approved parameters.

### FIELD

The present disclosure relates to data analytics for transaction data.

### BACKGROUND

Large data sets may exist in various sizes and with various levels of organization. With big data comprising data sets as large as ever, the volume of data collected incident to the increased popularity of online and electronic transactions continues to grow. Billions of rows and hundreds of thousands of columns worth of data may populate a single table, for example. An example of the use of big data is in identifying and categorizing business spending and consumer spending, which is frequently a key priority for transaction card issuers. In that regard, transactions processed by the transaction card issuer are massive in volume and comprise tremendously large data sets.

Large data sets may have challenges. For example, cardholders may transact business at a variety of merchants. Merchants may be desired to be classified, such as by industry. However, assigned industry codes may be inaccurate. Moreover, assigned industry codes may be accurate, but may be insufficiently precise to provide desired information about the nature of the business of the merchant within a broad industry. Such inaccuracy and imprecision may confuse and frustrate the identification and categorization of transaction data, and obscure the identity and categorization of real-world entities and individuals behind transactions, while also hampering data analytics.

### SUMMARY

In accordance with various embodiments, a VIC (verified merchant industry code) assignment system is disclosed. The VIC assignment system may include a processor, a tangible, non-transitory memory configured to communicate with the processor. The tangible, non-transitory memory may have instructions stored thereon that, in response to execution by the processor, cause the processor to perform operations. The VIC assignment system may include a text mining code assignment subsystem in communication with the processor and configured to ingest merchant name data and extract a merchant name. The VIC assignment system may include a closed loop code assignment subsystem in communication with the processor and configured to ingest closed loop data and determine a VIC code of a merchant in response to the closed loop data. The VIC assignment system may include an analytic characteristic code assignment subsystem in communication with the processor and configured to ingest machine learning instructions (for instance, kNN instructions) including directives indicating one or more processing rule for determining the VIC code of the merchant and further configured to ingest transaction data, wherein the analytic characteristic code assignment subsystem processes the transaction data according to the machine learning instructions (for instance, kNN instructions), whereby the VIC code of the merchant is determined. The VIC assignment system may include external commercial data retrieval subsystem in communication with the processor and configured to ingest third-party data and provided it to at least one of the closed loop code assignment subsystem and the analytic characteristic code assignment subsystem. The VIC assignment system may include an industry code determination bus disposed in logical communication with the text mining code assignment subsystem, the closed loop code assignment subsystem, the external commercial data retrieval subsystem, and the analytic characteristic code assignment subsystem. The VIC assignment system may include an industry code determination bus controller disposed in logical communication with the industry code determination bus and configured to direct communication among the text mining code assignment subsystem, the closed loop code assignment subsystem, and the analytic characteristic code assignment subsystem, and a network. The industry code determination bus controller may include an arbitration protocol engine configured to implement an arbitration protocol in response to arbitration rules data from an arbitration rules data source whereby a confidence score for the at least one VIC code is determined.

In various embodiments, the VIC assignment system may include a merchant name data source in logical communication with the text mining code assignment subsystem and configured to provide the merchant name data.

In various embodiments, the VIC assignment system may include a submission data source in logical communication with the closed loop code assignment subsystem, wherein the submission data source includes submission data related to the merchant that is self-reported by the merchant, wherein the closed loop data includes the submission data.

In various embodiments, the VIC assignment system may include an issuer data source in logical communication with the closed loop code assignment subsystem, wherein the issuer data source includes issuer data related to the merchant including an authorization code whereby a transaction is instantiated.

In various embodiments, the text mining code assignment subsystem is configured to transmit the merchant name to the industry code determination bus.

In various embodiments, the text mining code assignment subsystem is configured to assign the VIC code to the merchant in response to the extracting the merchant name.

In various embodiments, the closed loop code assignment subsystem is further configured to transmit at least one of the VIC code and an industry of the merchant to the industry code determination bus.

In various embodiments, the closed loop code assignment subsystem is further configured to transmit at least one of data from the submission data source and data from the issuer data source to the industry code determination bus.

In various embodiments, the transaction data ingested by the analytic characteristic code assignment subsystem includes transaction data from a transactions data repository.

In various embodiments, the transactions data repository includes merchant characteristics.

In various embodiments, the transactions data repository includes customer characteristics.

In various embodiments, the transactions data repository includes merchant characteristics and customer characteristics associated together by transactions between the merchant and the customer.

In various embodiments, the analytic characteristic code assignment subsystem is further configured to transmit the transaction data to the industry code determination bus.

A VIC assignment network is disclosed. The VIC assignment network may include a VIC assignment system configured to determine data including a VIC code of a merchant, wherein the VIC assignment system directs the data including the VIC code to be stored. The VIC assignment network may include a distributed storage system including a plurality of nodes, the distributed storage system configured to direct at least one of submission data, issuer data, and merchant name data to the VIC assignment system. The VIC assignment network may include a telecommunications transfer channel including a network logically connecting the VIC assignment system to the distributed storage system.

A VIC identification methodology is disclosed. The methodology may include ingesting by a text mining code assignment subsystem merchant name data, extracting by the text mining code assignment subsystem a merchant name from the merchant name data and determining a VIC code of the merchant in response to the merchant name, ingesting by a closed loop code assignment subsystem closed loop data, determining the VIC code of a merchant in response to the closed loop data, and ingesting, by an analytic characteristic code assignment subsystem, machine learning instructions (for instance, kNN instructions) including directives indicating one or more processing rule for determining a VIC code of a merchant. The methodology may include ingesting, by the analytic characteristic code assignment subsystem, transaction data, wherein the analytic characteristic code assignment subsystem processes the transaction data according to the machine learning instructions (for instance, kNN instructions), determining, by the analytic characteristic code assignment subsystem, the VIC code of the merchant in response to the processing, transmitting, by the analytic characteristic code assignment subsystem, the VIC code to an industry code determination bus disposed in logical communication with the analytic characteristic code assignment subsystem, and directing by an industry code determination bus controller disposed in logical communication with the industry code determination bus the VIC code to a network.

The forgoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may be obtained by referring to the detailed description and claims when considered in connection with the drawing figures, wherein like numerals denote like elements.

FIG. 1 illustrates an exemplary system for distributed storage and distributed processing, in accordance with various embodiments;

FIG. 2 illustrates an exemplary system for verified merchant industry code assignment and an exemplary system for assigned code usage, in accordance with various embodiments;

FIG. 3 illustrates an exemplary text mining code assignment of a system according to FIG. 2, in accordance with various embodiments;

FIG. 4 illustrates an exemplary analytic characteristic code assignment of a system according to FIG. 2, in accordance with various embodiments; and

FIG. 5 illustrates an exemplary industry code determination arbitration protocol of a system according to FIG. 2, in accordance with various embodiments.

### DETAILED DESCRIPTION

The detailed description of various embodiments herein makes reference to the accompanying drawings and pictures, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

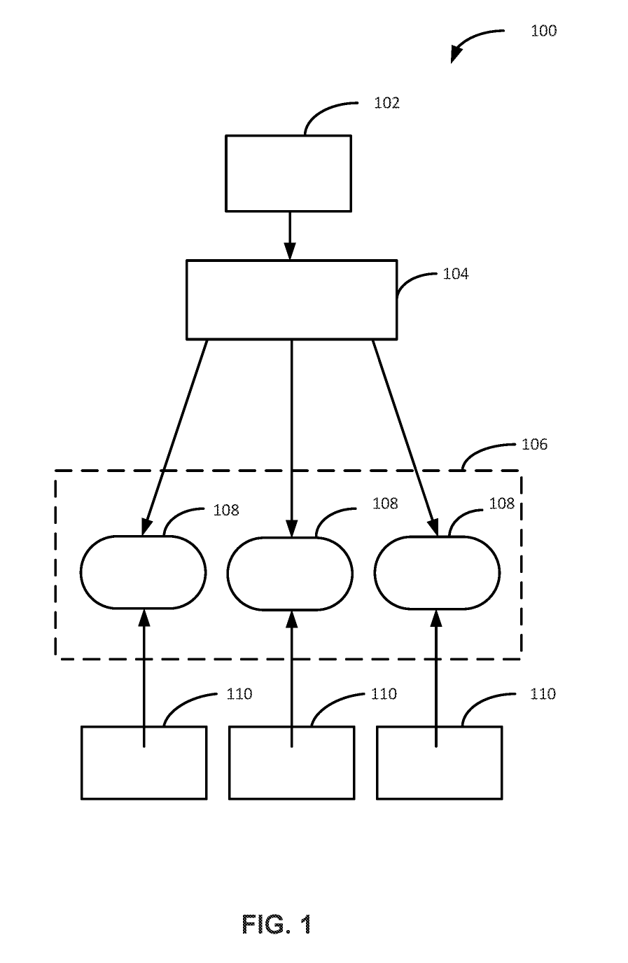

With reference to FIG. 1, system 100 for distributed data storage and processing is shown, in accordance with various embodiments. System 100 may comprise a verified merchant industry code (VIC) assignment system 102. VIC assignment system 102 may comprise any device capable of receiving and/or processing an electronic message via telecommunications transfer channel 104. Telecommunications transfer channel 104 may comprise a network. VIC assignment system 102 may take the form of a computer or processor, or a set of computers/processors, although other types of computing units or systems may be used, including laptops, notebooks, hand held computers, personal digital assistants, cellular phones, smart phones (e.g., iPhone®, BlackBerry®, Android®, etc.) tablets, wearables (e.g., smart watches and smart glasses), or any other device capable of receiving data over telecommunications transfer channel 104.

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., iPhone®, Blackberry®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBIOS, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

A network may be unsecure. Thus, communication over the network may utilize data encryption. Encryption may be performed by way of any of the techniques now available in the art or which may become available—e.g., Twofish, RSA, El Gamal, Schorr signature, DSA, PGP, PKI, GPG (GnuPG), and symmetric and asymmetric cryptography systems.

In various embodiments, VIC assignment system 102 may interact with distributed storage system 106 for storage and/or processing of big data sets. As used herein, big data may refer to partially or fully structured, semi-structured, or unstructured data sets including millions of rows and hundreds of thousands of columns. A big data set may be compiled, for example, from a history of purchase transactions over time, from web registrations, from social media, from records of charge (ROC), from summaries of charges (SOC), from internal data, or from other suitable sources. Big data sets may be compiled without descriptive metadata such as column types, counts, percentiles, or other interpretive-aid data points.

In various embodiments, distributed storage system 106 may comprise one or more nodes 108. Nodes 108 may comprise computers or processors the same as or similar to VIC assignment system 102. Nodes 108 may be distributed geographically in different locations, housed in the same building, and/or housed in the same rack. Nodes 108 may also be configured to function in concert to provide storage space and/or processing power greater than one of a node 108 might provide alone. As a result, distributed storage system 106 may collect and/or store the data 110. Data 110 may be collected by nodes 108 individually and compiled or in concert and collated. Data 110 may further be compiled into a data set and formatted.

In various embodiments, data 110 may comprise a collection of data including and/or originating from cardholder information, transaction information, account information, record of sales, account history, customer history, sensor data, machine log data, data storage system, public web data, and/or social media. Data 110 may be collected from multiple sources and amalgamated into a big data structure such as a file, for example. In that regard, the data may be used as an input to generate metadata describing the big data structure itself, as well as the data stored in the structure.

The distributed storage system 106 may comprise a transaction network. A VIC assignment system 102 may comprise various modules and engines as discussed herein wherein one or more VIC code is assigned to an individual or entity comprising a merchant, such as may be evaluated for establishing proper usage of differentiated transaction instruments according to their proper purposes. For instance, a VIC code may be assigned to a merchant identified as being associated with a transaction, whereby the transaction network may tailor the handling of the transaction, such as by denying it, whereby the transaction network may actively deter misuse of transaction products not intended for such merchants, and/or such as by allowing it and or delivering value-added services, such as electronically provided advertisements and/or offers, and/or other credit and/or lending products, whereby the transaction network more properly functions according to approved parameters. A VIC code may comprise a series of characters that identify the industry in which a business is categorized. A business may be assigned multiple VIC codes, for instance, a gas station may be assigned a VIC code associated with a vehicle refueling business, and a second VIC code associated with a convenience store business.

Moreover, such identifications enhance credit risk discrimination, identification of businesses and consumers associated with a business organization and the VIC code of that business organization. Such identifications enable the promotion of relevant merchants to relevant cardholders such as to promote business-to-business relationship building and/or potential business-to-business relationships, fraud detection, credit risk evaluation, dispute arbitration, and/or interoperation with third-parties desiring VIC code data.

In various embodiments, a VIC code assignment involves multiple complex and interactive machine steps. For instance, by evaluating the data 110 at a transaction level, assessing the nature of a transaction at the individual transaction level provides sufficient granularity. Data may be evaluated at the transaction level and/or aggregated such as to determine if a cardholder (or supplementary card holder, or a third-party merchant with whom cardholders or supplementary card holders engage in transactions, or any other transaction party) may be assigned a VIC code, or whether a previously assigned merchant categorization is or is not accurate. Moreover, such identification may be combined with or enhance the identification of such aspects as card product type, merchant industry codes, transaction amounts, number of transactions by an individual or a business in an industry (or at a particular merchant in an industry), determination of gross sales, removal of noise inducing transactions, and/or controlling for transactions having similar profiles (such as to facilitate further data processing).

Thus, it may be appreciated that in view of the preceding discussion, VIC assignments may facilitate the identification of credit risk, likelihood of fraud (for instance, consumer-oriented transactions on a business oriented transaction card indicating fraudulent use or business-oriented transactions on a consumer oriented transaction card indicating liquidity/access-to-capital problems and elevated default risk for the business), identification and classification of business-to-business transactions and counterparties to the transactions to facilitate marketing, and tailoring of online ad experiences. Even furthermore, cardholders having transactions at merchants indicated to be inconsistent with their card type can be cross-marketed other card types and credit limits established. VIC determinations may further leverage text mining on names and addresses to and machine learning methodologies (e.g., gradient boosting decision trees) to identify the non-linear patterns of behavior exhibited by cardholders and merchants.

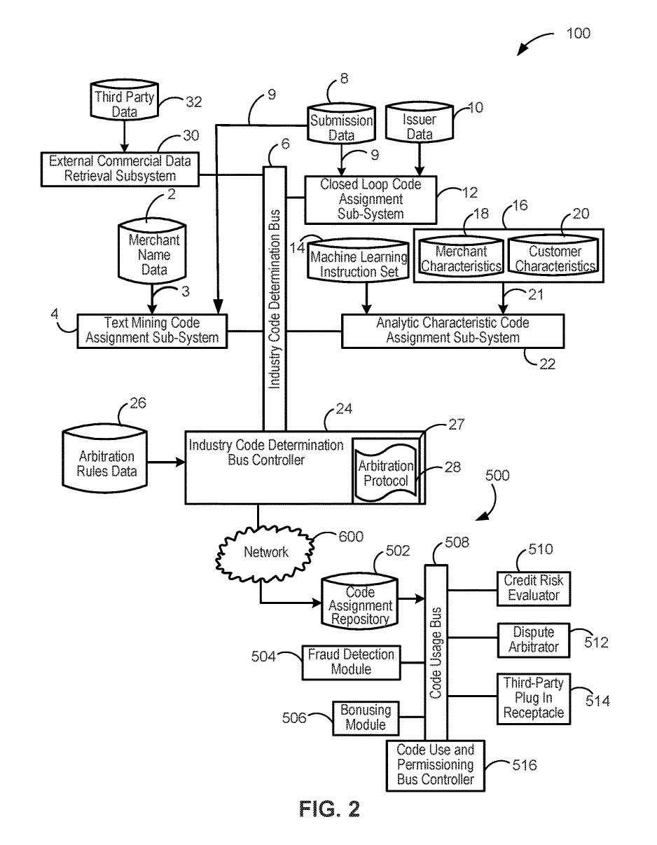

In various embodiments, and with reference to FIG. 2, a VIC assignment system 102 is described in more particular detail. For instance, a VIC assignment system 102 may comprise various logical modules configured to perform various operations and processes in accordance with methods disclosed herein.

A VIC assignment system 102 may comprise a merchant name data source 2, and/or submission data source 8, a third-party data source 32 and/or issuer data source 10, and/or KNN instruction set data source 14, and or transaction characteristics data source 16, and/or arbitration rules data source 26. In further embodiments, the VIC assignment system 102 does not comprise one or more of these sources. Rather (with reference to FIGS. 1 and 2), the data 110 from nodes 108 of distributed storage system 106 comprises one or more of the sources from which data is provided to a VIC assignment system 102.

A VIC assignment system 102 may comprise a merchant name data source 2. A merchant name data source 2 may comprise a repository of merchant name data 3. For instance, a name of a merchant business, such as “Wal-Mart” or “Exxon” or “Fishing Store” or any other name may be associated with a business. Data indicative of this associated name may be reposed in a merchant name data source 2. The merchant name data source 2 may comprise data indicative of a name of a merchant business that is self reported by the merchant, such as at the time that the merchant signed up for a merchant account with a transaction card provider or such as provided by the merchant business during submission of a ROC for clearance as a part of a transaction. The merchant name data source 2 may comprise third-party database data, for example business directories such as from Yellow Pages, or business intelligence data, such as from Dun & Bradstreet, or credit reporting agency data, such as from Equifax, and/or the like. Moreover, merchant name data 3 may arise from internal and/or proprietary sources, such as card issuer transaction processing records.

A VIC assignment system 102 may comprise a third-party data source 32. A third-party data source 32 may comprise data originating from outside the VIC assignment system 102. For instance, a third-party data source may comprise third-party database data, for example business directories such as from Yellow Pages, or business intelligence data, such as from Dun & Bradstreet, or credit reporting agency data, such as from Equifax, and/or the like. A third-party data source may comprise data provided by merchants, social networks, and/or the like.

With reference to FIGS. 2, 3, and 4, a VIC assignment system 102 may comprise a submission data source 8. A submission data source 8 may comprise submission data 9 related to a merchant that is self-reported by the merchant. For example, submission data 9 may include self-reported industry classification, such as may be reported by a merchant we setting up a merchant account with the transaction card issuer. Submission data 9 may comprise one or more submission ROC descriptor. Furthermore, the submission data source 8 may be subject to refinement, updating, and augmentation. For instance, the industry code determination bus controller 24 discussed further herein may apply machine learning techniques such as discussed herein to correct errors in the submission data 9, or to improve the quality or quantity of the submission data 9 over time.

A VIC assignment system 102 may comprise an issuer data source 10. An issuer data source 10 may comprise issuer data related to a merchant. For example, a merchant having a merchant account with a transaction card issuer may have associated authorization codes whereby transactions may be instantiated. These authorization codes may be mapped to internal data of the transaction card issuer, such as may be reposed in an issuer data source 10.

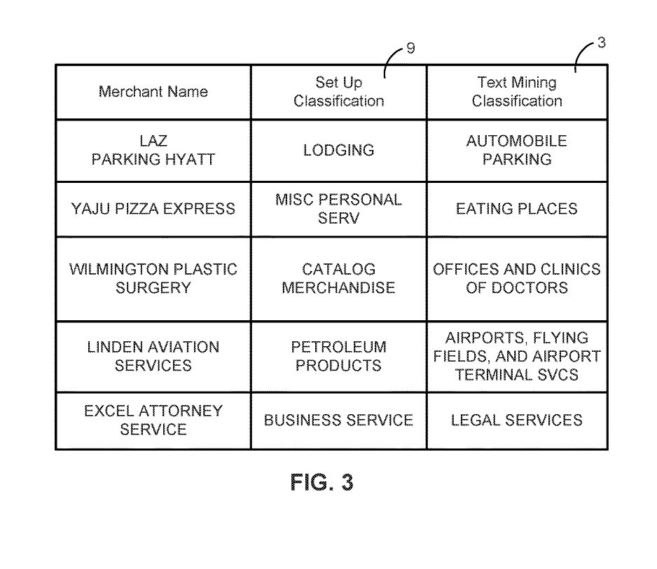

With reference to FIGS. 2 and 3, a VIC assignment system 102 may comprise a text mining code assignment subsystem 4. A text mining code assignment subsystem 4 may comprise a text mining engine configured to ingest merchant name data 3 from a merchant name data source 2 and/or submission data 9 from a submission data source 8 and process the data to extract the merchant names. For instance, merchant name data 3 and/or submission data 9 may comprise noise, for instance, data not comprising the merchant name. The text mining code assignment subsystem 4 comprising a text mining engine may parse the text of the merchant name data 3 and/or submission data 9 and discard the portions not representative of a merchant name and keep the portions representative of a merchant name. In various embodiments, the text mining code assignment subsystem 4 may cross-reference the portions representative of a merchant name to a dictionary of merchant industries. In this manner, the industry of the merchant may be determined in response to the merchant name. Accordingly, the text mining code assignment subsystem 4 may assign a VIC code to the merchant in response to the determining. At least one of the VIC code, the industry of the merchant, and the merchant name may be transmitted by the text mining code assignment subsystem 4 to an industry code determination bus 6 for further processing. Moreover, in various embodiments, the merchant name data 3 may be transmitted to an industry code determination bus 6, such as for processing by different aspects of the VIC assignment system 102. In various embodiments, the text mining code assignment subsystem 4 implements fuzzy logic whereby noise (e.g., unwanted content) may be removed from the merchant name data 3, thereby further enhancing the parsing of the text of the marchant name data 3.

A VIC assignment system 102 may comprise a closed loop code assignment subsystem 12. A closed loop code assignment subsystem 12 may comprise a closed loop engine configured to ingest closed loop data and process the data to determine a VIC code of a merchant. For example, closed loop data may comprise submission data 9 from a submission data source 8. Furthermore, closed loop data may comprise issuer data from an issuer data source 10. The closed loop code assignment subsystem 12 may ingest one or both and may determine at least one of the VIC code and the industry of the merchant in response. For example, closed loop data may comprise data collected by the transaction card issuer during the process of transaction authorization. In various embodiments, the closed loop code assignment subsystem 12 may assign a VIC code and/or determine an industry of the merchant in response to processing the data from the submission data source 8 and/or the issuer data source 10. At least one of the VIC code and the industry of the merchant may be transmitted by the closed loop code assignment subsystem 12 to an industry code determination bus 6 for further processing. In further embodiments, the closed loop code assignment subsystem 12 may transmit all or a portion of the data from the submission data source 8 and/or the issuer data source 10 to an industry code determination bus 6, such as for processing by different aspects of the VIC assignment system 102.

A VIC assignment system 102 may comprise an external commercial data retrieval sub-system 30. An external commercial data retrieval sub-system 30 may be configured to ingest third party data from a third party data source 32 and process the data determine a VIC code of a merchant, an industry of a merchant, and/or to provide this data to other aspects of the VIC assignment system 102 via the industry code determination bus 6. In further embodiments, the external commercial data retrieval sub-system 30 may transmit all or a portion of the data from the third party data source 32 to the industry code determination bus 6, such as for processing by different aspects of the VIC assignment system 102.

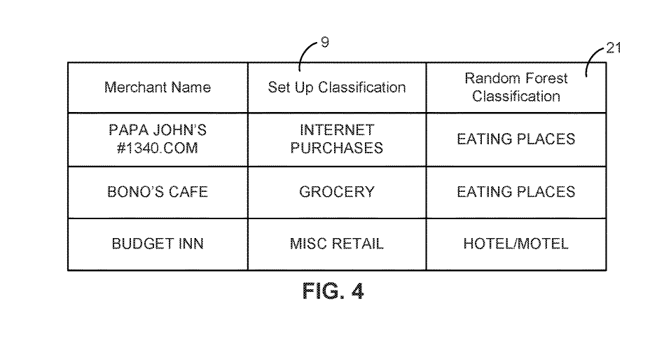

With reference to FIGS. 2 and 4, a VIC assignment system 102 may comprise an analytic characteristic code assignment subsystem 22. An analytic characteristic code assignment subsystem 22 may ingest machine learning instructions (for instance, kNN instructions) from a KNN instruction set data source 14. The machine learning instructions (for instance, kNN instructions) may comprise directives indicating to the analytic characteristic code assignment subsystem 22 one or more processing rule for determining a VIC code in response to data, such as by machine learning. The analytic characteristic code assignment subsystem 22 may receive transaction data 21 from a transaction characteristics data source 16 comprising merchant characteristics 18 and customer characteristics 20 associated together by transactions between the merchant and customer. The analytic characteristic code assignment subsystem 22 may process the transaction data 21 according to the KNN instruction set data source 14 and produce at least one of a VIC code and an industry of the merchant which may be transmitted by the analytic characteristic code assignment subsystem 22 to an industry code determination bus 6 for further processing. In further embodiments, the analytic characteristic code assignment subsystem 22 may transmit all or a portion of the transaction data 21 to an industry code determination bus 6 such as for processing by different aspects of the VIC assignment system 102.

A VIC assignment system 102 may comprise an industry code determination bus 6 as mentioned. Each of the closed loop code assignment subsystem 12, text mining code assignment subsystem 4, and analytic characteristic code assignment subsystem 22 may interoperate via industry code determination bus 6 by transceiving messages and data, and may perform various calculations, decisions, and operations in accordance with the teachings herein. Moreover, VIC assignment system 102 may further comprise an industry code determination bus controller 24 configured to manage communications among modules on the industry code determination bus 6, and direct various modules to perform various operations and processes in accordance with methods disclosed herein, as well as direct communications with external components such as distributed storage system 106, nodes 108, and/or the like.

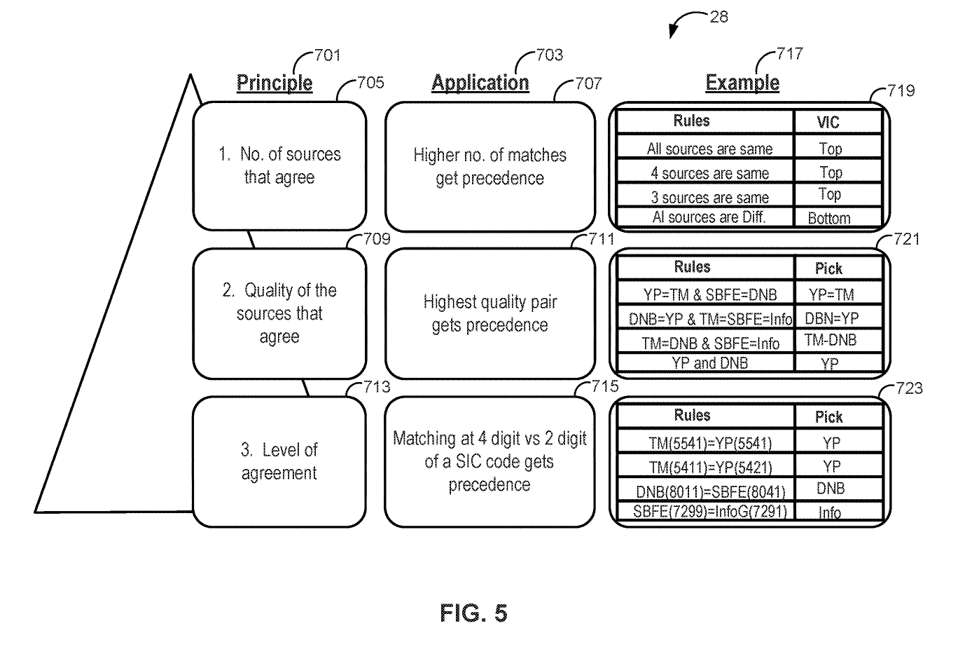

With reference to FIGS. 2 and 5, in various embodiments, the industry code determination bus controller 24 further comprises an arbitration protocol engine 27. The arbitration protocol engine 27 implements an arbitration protocol 28 in response to arbitration rules data from an arbitration rules data source 26. The arbitration protocol 28 comprises a mechanism whereby the industry code determination bus controller 24 determines a confidence score for a VIC code assigned by each of the subsystems 12, 4, 22, and arbitrates among the different sub-systems to make a final VIC code assignment. In this manner, the accuracy and precision of VIC code assignment may be enhanced based on the confidence score(s).

In various embodiments, an arbitration protocol may comprise one or more principle 701. A principle 701 is a rule that is implemented to determine which VIC code assigned by each of a source (e.g., sub-system 4, 12, 22) to assign as a final VIC code assignment. Each principle 701 may have an application 703, for instance, a rule implementing the principle 701 so that it can be adhered to by machine learning. Finally, each principle 701 may be associated with an example 717 illustrating the application 703 of the principle 701 on data.

For example, a principle 701 may comprise a number of sources in agreement 705. An application 703 of a number of sources in agreement 705 may be that a higher number of matches get precedent 707. In other words, according to example 719, a VIC code may be assigned in response to more of sub-systems 4, 12, 22, or in response to more data sources feeding the subsystems 4, 12, 22 agreeing on a final VIC code.

Moreover, a principle 701 may comprise a quality of the sources that agree 709. An application 703 of a quality of the sources that agree 709 may be that the highest quality pair of sources in agreement receive precedence 711. In other words, according to example 721, a VIC code may be assigned in response to agreement among sub-systems 4, 12, 22, or data sources feeding the subsystems 4, 12, 22 on a fina VIC code, wherein the agreeing sub-systems or data sources are historically accurate (e.g., have a greater number of recorded correct VIC code assignments than other sub-systems or data sources).

Furthermore, a principle 701 may comprise a level of agreement 713. An application 703 of a level of agreement 713 may be that precedence is assigned to the subsystem 4, 12, 22 and/or data source feeding the subsystems 4, 12, 22 that matches one or more other subsystem and/or data source for at least four digits of a SIC code (Standard Industry Classification) code of the merchant being assigned a VIC code (and thus taking precedence over subsystems and/or data sources with fewer digits agree than four). In other words, according to example 723, a VIC code may be assigned in response to a sub-system 4, 12, 22 or data source feeding the subsystems 4, 12, 22 demonstrating agreement with at least one other sub-system 4, 12, 22 or data source feeding the subsystems 4, 12, 22 over more digits of a SIC code.

Following the arbitration, the industry code determination bus controller 24 may transmit the final VIC code assignment data to a network 600 for distribution among various external systems.

For instance, a VIC code usage system 500 may comprise a code usage bus 508 under the control of a code use and permissioning bus controller 516 and one or more modules configured to ingest a final VIC code assignment. For instance, the VIC code usage system 500 may comprise one or more of at least one code assignment repository 502, fraud detection module 504, bonusing module 506, credit risk evaluator 510, dispute arbitrator 512, and/or third-party plug in receptacle 514. In various embodiments, the code assignment repository 502 may comprise a database configured to store final VIC code assignments for one or more merchant. A fraud detection module 504 may comprise a module configured to determine potentially fraudulent activity (for example, the final VIC code assignment indicated that a merchant is in an industry in which a card member has never transacted). A bonusing module 506 may comprise a module configured to provide bonuses and/or other offers, such as to merchants for which the final VIC code assignment indicates that the merchant is in an industry with low numbers of transactions. The credit risk evaluator 510 may comprise a module configured to determine a credit risk of a merchant, such as to determine that the final VIC code assignment indicates that the merchant is in an industry prone to default and/or bankruptcy. A dispute arbitrator 512 may comprise a module configured to resolve merchant to customer disputes such as to determine that the final VIC code assignment indicates that the merchant is in an industry prone to criminal activity. A third-party plug in receptacle 514 may comprise a module configured to provide the final VIC code assignment to authorized third parties.

Data, as discussed herein, may include “internal data.” Internal data may include any data a credit issuer possesses or acquires pertaining to a particular consumer. Internal data may be gathered before, during, or after a relationship between the credit issuer and the transaction account holder (e.g., the consumer or buyer). Such data may include consumer demographic data. Consumer demographic data includes any data pertaining to a consumer. Consumer demographic data may include consumer name, address, telephone number, email address, employer and social security number. Consumer transactional data is any data pertaining to the particular transactions in which a consumer engages during any given time period. Consumer transactional data may include, for example, transaction amount, transaction time, transaction vendor/merchant, and transaction vendor/merchant location. Transaction vendor/merchant location may contain a high degree of specificity to a vendor/merchant. For example, transaction vendor/merchant location may include a particular gasoline filing station in a particular postal code located at a particular cross section or address. Also, for example, transaction vendor/merchant location may include a particular web address, such as a Uniform Resource Locator (“URL”), an email address and/or an Internet Protocol (“IP”) address for a vendor/merchant. Transaction vendor/merchant and transaction vendor/merchant location may be associated with a particular consumer and further associated with sets of consumers. Consumer payment data includes any data pertaining to a consumer's history of paying debt obligations. Consumer payment data may include consumer payment dates, payment amounts, balance amount, and credit limit. Internal data may further comprise records of consumer service calls, complaints, requests for credit line increases, questions, and comments. A record of a consumer service call includes, for example, date of call, reason for call, and any transcript or summary of the actual call.

Any communication, transmission and/or channel discussed herein may include any system or method for delivering content (e.g. data, information, metadata, etc.), and/or the content itself. The content may be presented in any form or medium, and in various embodiments, the content may be delivered electronically and/or capable of being presented electronically. For example, a channel may comprise a website or device (e.g., Facebook, YouTube®, AppleTV®, Pandora®, xBox®, Sony® Playstation®), a uniform resource locator (“URL”), a document (e.g., a Microsoft Word® document, a Microsoft Excel® document, an Adobe .pdf document, etc.), an “ebook,” an “emagazine,” an application or microapplication (as described herein), an SMS or other type of text message, an email, Facebook, twitter, MMS and/or other type of communication technology. In various embodiments, a channel may be hosted or provided by a data partner. In various embodiments, the distribution channel may comprise at least one of a merchant website, a social media website, affiliate or partner websites, an external vendor, a mobile device communication, social media network and/or location based service. Distribution channels may include at least one of a merchant website, a social media site, affiliate or partner websites, an external vendor, and/or a mobile device communication. Examples of social media sites include Facebook®, foursquare®, Twitter®, My Space®, LinkedIn° , and the like. Examples of affiliate or partner websites include American Express®, Groupon®, LivingSocial®, and the like. Moreover, examples of mobile device communications include texting, email, and mobile applications for smartphones.

A “consumer profile,” “customer data,” or “consumer profile data” may comprise any information or data about a consumer that describes an attribute associated with the consumer (e.g., a preference, an interest, demographic information, personally identifying information, and the like).

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., Windows NT®, Windows 95/98/2000®, Windows XP®, Windows Vista®, Windows 7®, OS2, UNIX®, Linux®, Solaris®, MacOS, etc.) as well as various conventional support software and drivers typically associated with computers.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations. Useful machines for performing the various embodiments include general purpose digital computers or similar devices.

In fact, in various embodiments, the embodiments are directed toward one or more computer systems capable of carrying out the functionality described herein. The computer system includes one or more processors, such as processor. The processor is connected to a communication infrastructure (e.g., a communications bus, cross over bar, or network). Various software embodiments are described in terms of this exemplary computer system. After reading this description, it will become apparent to a person skilled in the relevant art(s) how to implement various embodiments using other computer systems and/or architectures. Computer system can include a display interface that forwards graphics, text, and other data from the communication infrastructure (or from a frame buffer not shown) for display on a display unit.

Computer system also includes a main memory, such as for example random access memory (RAM), and may also include a secondary memory. The secondary memory may include, for example, a hard disk drive and/or a removable storage drive, representing a floppy disk drive, a magnetic tape drive, an optical disk drive, etc. The removable storage drive reads from and/or writes to a removable storage unit in a well-known manner. Removable storage unit represents a floppy disk, magnetic tape, optical disk, etc. which is read by and written to by removable storage drive. As will be appreciated, the removable storage unit includes a computer usable storage medium having stored therein computer software and/or data.

In various embodiments, secondary memory may include other similar devices for allowing computer programs or other instructions to be loaded into computer system. Such devices may include, for example, a removable storage unit and an interface. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from the removable storage unit to computer system.

Computer system may also include a communications interface. Communications interface allows software and data to be transferred between computer system and external devices. Examples of communications interface may include a modem, a network interface (such as an Ethernet card), a communications port, a Personal Computer Memory Card International Association (PCMCIA) slot and card, etc. Software and data transferred via communications interface are in the form of signals which may be electronic, electromagnetic, and optical or other signals capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

The terms “computer program medium” and “computer usable medium” and “computer readable medium” are used to generally refer to media such as removable storage drive and a hard disk installed in hard disk drive. These computer program products provide software to computer system.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

In various embodiments, software may be stored in a computer program product and loaded into computer system using removable storage drive, hard disk drive or communications interface. The control logic (software), when executed by the processor, causes the processor to perform the functions of various embodiments as described herein. In various embodiments, hardware components such as application specific integrated circuits (ASICs). Implementation of the hardware to perform the functions described herein will be apparent to persons skilled in the relevant art(s).

The various system components may be independently, separately or collectively suitably coupled to the network via data links which includes, for example, a connection to an Internet Service Provider (ISP) over the local loop as is typically used in connection with standard modem communication, cable modem, Dish Networks®, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing at http://csrc.nist.gov/publications/nistpubs/800-145/SP800-145.pdf (last visited June 2012), which is hereby incorporated by reference in its entirety.

As used herein, “transmit” may include sending electronic data from one system component to another over a network connection. Additionally, as used herein, “data” may include encompassing information such as commands, queries, files, data for storage, and the like in digital or any other form.

The computers discussed herein may provide a suitable website or other Internet-based graphical user interface which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Interbase, etc., may be used to provide an Active Data Object (ADO) compliant database management system. In one embodiment, the Apache web server is used in conjunction with a Linux operating system, a MySQL database, and the Perl, PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), AJAX (Asynchronous Javascript And XML), helper applications, plug-ins, and the like. A server may include a web service that receives a request from a web server, the request including a URL (http://yahoo.com/stockquotes/ge) and an IP address (123.56.789.234). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. See, e.g., ALEX NGHIEM, IT WEB SERVICES: A ROADMAP FOR THE ENTERPRISE (2003), hereby incorporated by reference.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, VBScript, Macromedia Cold Fusion, COBOL, Microsoft Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

As will be appreciated by one of ordinary skill in the art, the system may be embodied as a customization of an existing system, an add-on product, a processing apparatus executing upgraded software, a standalone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, webpages, websites, web forms, prompts, etc. Practitioners will appreciate that the illustrated steps described herein may comprise in any number of configurations including the use of windows, webpages, web forms, popup windows, prompts and the like. It should be further appreciated that the multiple steps as illustrated and described may be combined into single webpages and/or windows but have been expanded for the sake of simplicity. In other cases, steps illustrated and described as single process steps may be separated into multiple webpages and/or windows but have been combined for simplicity.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. §101.

Systems, methods and computer program products are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims.

Furthermore, no element, component, or method step in the present disclosure is intended to be dedicated to the public regardless of whether the element, component, or method step is explicitly recited in the claims. No claim element herein is to be construed under the provisions of 35 U.S.C. 112 (f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A VIC assignment system comprising:
a processor,
a tangible, non-transitory memory configured to communicate with the processor, the tangible, non-transitory memory having instructions stored thereon that, in response to execution by the processor, cause the processor to perform operations;
a text mining code assignment subsystem in communication with the processor and configured to ingest merchant name data and extract a merchant name;
a closed loop code assignment subsystem in communication with the processor and configured configured to ingest closed loop data and determine an at least one VIC code of a merchant in response to the closed loop data;
an analytic characteristic code assignment subsystem in communication with the processor and configured to ingest machine learning instructions comprising directives indicating one or more processing rule for determining the at least one VIC code of the merchant and further configured to ingest transaction data, wherein the analytic characteristic code assignment subsystem processes the transaction data according to the machine learning instructions, whereby the at least one VIC code of the merchant is determined;
an external commercial data retrieval subsystem in communication with the processor and configured to ingest third-party data and provided it to at least one of the closed loop code assignment subsystem and the analytic characteristic code assignment subsystem;
an industry code determination bus disposed in logical communication with the text mining code assignment subsystem, the closed loop code assignment subsystem, the external commercial data retrieval subsystem, and the analytic characteristic code assignment subsystem; and
an industry code determination bus controller disposed in logical communication with the industry code determination bus and configured to direct communication among the text mining code assignment subsystem, the closed loop code assignment subsystem, the external commercial data retrieval subsystem, and the analytic characteristic code assignment subsystem, and a network,
wherein the industry code determination bus controller comprises an arbitration protocol engine configured to implement an arbitration protocol in response to arbitration rules data from an arbitration rules data source whereby a confidence score for the at least one VIC code is determined.

2. The VIC assignment system according to claim 1, further comprising a merchant name data source in logical communication with the text mining code assignment subsystem and configured to provide the merchant name data.

3. The VIC assignment system according to claim 1, further comprising:
a submission data source in logical communication with the closed loop code assignment subsystem, wherein the submission data source comprises submission data related to the merchant that is self-reported by the merchant, wherein the closed loop data comprises the submission data;
an issuer data source in logical communication with the closed loop code assignment subsystem, wherein the issuer data source comprises issuer data related to the merchant comprising an authorization code whereby a transaction is instantiated

4. The VIC assignment system according to claim 1, wherein the at least one VIC code comprises a first VIC code and a second VIC code.

5. The VIC assignment system according to claim 1, wherein the text mining code assignment subsystem is configured to transmit the merchant name to the industry code determination bus.

6. The VIC assignment system according to claim 1, wherein the text mining code assignment subsystem is configured to assign the at least one VIC code to the merchant in response to the extracting the merchant name.

7. The VIC assignment system according to claim 1, wherein the closed loop code assignment subsystem is further configured to transmit at least one of the at least one VIC code and an industry of the merchant to the industry code determination bus.

8. The VIC assignment system according to claim 1, wherein the closed loop code assignment subsystem is further configured to transmit at least one of data from a submission data source and data from an issuer data source to the industry code determination bus.

9. The VIC assignment system according to claim 1, wherein the transaction data ingested by the analytic characteristic code assignment subsystem comprises transaction data from a transactions data repository.

10. The VIC assignment system according to claim 9, wherein the transactions data repository comprises merchant characteristics.

11. The VIC assignment system according to claim 9, wherein the transactions data repository comprises customer characteristics.

12. The VIC assignment system according to claim 9, wherein the transactions data repository comprises merchant characteristics and customer characteristics associated together by transactions between the merchant and a customer.

13. The VIC assignment system according to claim 1, wherein the analytic characteristic code assignment subsystem is further configured to transmit the transaction data to the industry code determination bus.

14. A VIC assignment network comprising:
a VIC assignment system configured to determine data comprising an at least one VIC code of a merchant;
wherein the VIC assignment system directs the data comprising the at least one VIC code to be stored,
a distributed storage system comprising a plurality of nodes,
the distributed storage system configured to direct at least one of submission data, issuer data, and merchant name data to the VIC assignment system; and
a telecommunications transfer channel comprising a network logically connecting the VIC assignment system to the distributed storage system.

15. The VIC identification network according to claim 14, the VIC assignment system comprising:
a processor,
a tangible, non-transitory memory configured to communicate with the processor,
the tangible, non-transitory memory having instructions stored thereon that, in response to execution by the processor, cause the processor to perform operations;
a text mining code assignment subsystem in communication with the processor and configured to ingest merchant name data and extract a merchant name;
a closed loop code assignment subsystem in communication with the processor and configured to ingest closed loop data and determine the at least one VIC code of a merchant in response to the closed loop data;
an analytic characteristic code assignment subsystem in communication with the processor and configured to ingest machine learning instructions comprising directives indicating one or more processing rule for determining the at least one VIC code of the merchant and further configured to ingest transaction data, wherein the analytic characteristic code assignment subsystem processes the transaction data according to the machine learning instructions, whereby the at least one VIC code of the merchant is determined;
an external commercial data retrieval subsystem in communication with the processor and configured to ingest third-party data and provided it to at least one of the closed loop code assignment subsystem and the analytic characteristic code assignment subsystem;
an industry code determination bus disposed in logical communication with the text mining code assignment subsystem, the closed loop code assignment subsystem, the external commercial data retrieval subsystem, and the analytic characteristic code assignment subsystem; and
an industry code determination bus controller disposed in logical communication with the industry code determination bus and configured to direct communication among the text mining code assignment subsystem, the closed loop code assignment subsystem, the external commercial data retrieval subsystem, and the analytic characteristic code assignment subsystem, and the network,
wherein the industry code determination bus controller comprises an arbitration protocol engine configured to implement an arbitration protocol in response to arbitration rules data from an arbitration rules data source whereby a confidence score for the at least one VIC code is determined.

16. The VIC assignment system according to claim 15, further comprising a merchant name data source in logical communication with the text mining code assignment subsystem and configured to provide the merchant name data.

17. The VIC assignment system according to claim 15, further comprising a submission data source in logical communication with the closed loop code assignment subsystem, wherein the submission data source comprises submission data related to the merchant that is self-reported by the merchant, wherein the closed loop data comprises the submission data.

18. The VIC assignment system according to claim 15, further comprising an issuer data source in logical communication with the closed loop code assignment subsystem, wherein the issuer data source comprises issuer data related to the merchant comprising an authorization code whereby a transaction is instantiated.

19. The VIC assignment system according to claim 15, wherein the text mining code assignment subsystem is configured to transmit the merchant name to the industry code determination bus.

20. A VIC identification methodology comprising:
ingesting, by a text mining code assignment subsystem, merchant name data;
extracting, by the text mining code assignment subsystem, a merchant name from the merchant name data and determining an at least one VIC code of the merchant in response to the merchant name;
ingesting, by a closed loop code assignment subsystem, closed loop data;
determining, by the closed loop code assignment subsystem, the at least one VIC code of a merchant in response to the closed loop data;
ingesting, by an analytic characteristic code assignment subsystem, machine learning instructions comprising directives indicating one or more processing rule for determining the at least one VIC code of a merchant;
ingesting, by the analytic characteristic code assignment subsystem, transaction data, wherein the analytic characteristic code assignment subsystem processes the transaction data according to the machine learning instructions,
determining, by the analytic characteristic code assignment subsystem, the at least one VIC code of the merchant in response to the processing;
transmitting, by the analytic characteristic code assignment subsystem, the at least one VIC code to an industry code determination bus disposed in logical communication with the analytic characteristic code assignment subsystem;
implementing, by an industry code determination bus controller disposed in logical communication with the industry code determination bus, an arbitration protocol in response to arbitration rules data from an arbitration rules data source whereby a confidence score for the at least one VIC code is determined; and
directing, by the industry code determination bus controller disposed in logical communication with the industry code determination bus, the at least one VIC code to a network.
